(19) United States
(12) Patent Application Publication
(10) Pub. No.: US 2023/0365220 A1
(43) Pub. Date: Nov. 16, 2023

(54) CUSTOM USER ACCELERATION AND SPEED SETPOINT PROFILES

(71) Applicant: Euphree, Inc., Houston, TX (US)

(72) Inventor: Daniel BASALDUA, Houston, TX (US)

(21) Appl. No.: 17/745,191

(22) Filed: May 16, 2022

(51) Int. Cl. B62M 6/50; B62M 1/12; B62M 25/04; B62J 43/13; B62J 45/20; B62J 50/22

(52) U.S. Cl. CPC B62M 6/50; B62M 1/12; B62M 25/04; B62J 43/13; B62J 45/20; B62J 50/22

(57) ABSTRACT

A power assist propulsion system and a user-rideable vehicle. The power assist propulsion system includes a motorized propulsion subsystem configured to interface with a manual propulsion subsystem. The power assist propulsion system also includes a control system that includes memory storing a set of acceleration profiles and instructions. A processor communicatively coupled to the memory and the motorized propulsion subsystem executes the instructions to generate a customized acceleration profile based on inputs received from a user. The inputs define a number of operating modes, a speed setpoint for each of the number of operating modes, and a power output for each of the number of operating modes. The customized acceleration profile is saved as one of the set of acceleration profiles and the processor controls the motorized propulsion subsystem based on a selected acceleration profile from the set of acceleration profiles.

### TECHNICAL FIELD

The present disclosure relates in general to the field of vehicle propulsion systems, and more particularly to user-rideable vehicles with a motorized propulsion subsystem for controlling operation of the user-rideable vehicle according to one of a set of acceleration profiles.

### BACKGROUND

Common examples of manually powered, user-rideable vehicles include wheelchairs, boats, and bicycles. Wheelchairs and boats have long since been offered with forms of motorized propulsion, i.e., battery- and/or gas-operated motors, respectively. Motorized propulsion for two-wheeled vehicles, such as bicycles, evolved into motorcycles and mopeds. However, consumers have recently expressed an increased interest in bicycles with motors, which allows for the operator to enjoy the benefits associated with manual operation of the bicycle but exploit the motor to obtain a powered assist resulting in increased acceleration or higher top speed, when necessary. The powered assist is often provided by a battery-powered electric motor. Consequently, these bicycles are often colloquially referred to as electric bicycles, i.e., E-Bikes.

One popular type of power assist feature offered in conventional E-Bikes utilizes a sensor, such as a torque or cadence sensor, at the base of the crankshaft of one or both pedals. The sensor(s) senses if the rider is pedaling and/or the input force exerted by the rider at the pedals. As this input force is detected, a computing device mounted on the E-Bike employs the electric motor to generate an amount of power assist that is directly proportional to the sensed input force. As a rider increases the amount of force applied to the pedals, e.g., as would be needed to accelerate the E-Bike from a standstill to a cruising speed, the amount of power assist provided is increased. Conversely, as the E-Bike's speed approaches the cruising speed, the amount of force applied at the pedals is reduced, resulting in a commensurate reduction in the amount of power assist supplied by the electric motor. And if the rider is “coasting” on the E-Bike and providing no motive force to propel the E-Bike, the electric motor provides no power assist. While other types of power assist also exists where the amount of power assist provided varies in response to certain conditions and various other features, the general principle of providing power assist on an E-Bike remains unchanged.

Many conventional E-Bikes also include a throttle that operates in the same or similar manner as throttles employed in motorcycles, i.e., the amount of acceleration is proportional to the amount of actuation applied to the throttle. The throttle can also provide a motive force that allows the E-Bike to maintain a cruising speed without any change in acceleration.

### SUMMARY

Novel aspects of the present disclosure are directed to a power assist propulsion system that includes a motorized propulsion subsystem configured to interface with a manual propulsion subsystem. The motorized propulsion subsystem can propel the vehicle in concert with the manual propulsion subsystem or independently of the manual propulsion subsystem. The power assist propulsion system also includes a control system that includes memory storing a set of acceleration profiles and instructions, and a processor communicatively coupled to the memory and the motorized propulsion subsystem executes the instructions to generate a customized acceleration profile based on inputs received from a user. The inputs define a number of operating modes, a speed setpoint for each of the number of operating modes, and a power output for each of the number of operating modes. The customized acceleration profile is saved as one of the set of acceleration profiles and the processor controls the motorized propulsion subsystem based on a selected acceleration profile from the set of acceleration profiles.

Novel aspects of the present disclosure are also directed to a vehicle including a manual propulsion subsystem and a power assist propulsion system coupled with the manual propulsion system. The power assist propulsion system includes a motorized propulsion subsystem that interfaces with the manual propulsion subsystem. The motorized propulsion subsystem can propel the vehicle in concert with the manual propulsion subsystem or independently of the manual propulsion subsystem. The power assist propulsion system also includes a control system that includes memory storing a set of acceleration profiles and instructions. The power assist propulsion system also includes a processor communicatively coupled to the memory and the motorized propulsion subsystem. The processor executes the instructions to generate a customized acceleration profile based on inputs received from a user which define a number of operating modes, a speed setpoint for each of the number of operating modes, and a power output for each of the number of operating modes. The customized acceleration profile is saved as one of the set of acceleration profiles and the processor controls the motorized propulsion subsystem based on a selected acceleration profile from the set of acceleration profiles.

Other aspects, embodiments and features of the invention will become apparent from the following detailed description of the invention when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying figures, wherein:

FIG. 1 is a schematic diagram of a user-rideable vehicle in accordance with an illustrative embodiment;

FIGS. 2A and 2B are exemplary acceleration profiles in accordance with an illustrative embodiment;

FIG. 3 is a block diagram of a power assist propulsion system for a user-rideable vehicle in accordance with an illustrative embodiment;

FIG. 4 is a block diagram of a control system in accordance with an illustrative embodiment;

FIG. 5 is a flowchart of a process for selecting one of a plurality of acceleration profiles in accordance with an illustrative embodiment;

FIG. 6 is a flowchart of another process for selecting one of a plurality of acceleration profiles in accordance with an illustrative embodiment; and

FIG. 7 is a swim lane diagram depicting data flow for creating a customized acceleration profile in accordance with an illustrative embodiment.

### DETAILED DESCRIPTION

The following detailed description includes exemplary embodiments of the inventive principles disclosed herein, and reference is made to the accompanying figures that form a part hereof. The figures here are shown to only illustrate specific embodiments in which the disclosed principles may be practiced. It must be understood, however, that other embodiments may be implemented that include structural changes and modifications made without departing from the scope of the disclosed principles.

The increasingly widespread adoption of E-Bikes by consumers means that E-Bike manufacturers have a difficult, if not impossible task of creating a vehicle with a power assist propulsion system that appeals to a broad spectrum of users across a broad spectrum of use cases. For example, users can vary in age, skillset, an operating environment, which results in numerous different permutations of power assist propulsion systems configurations. For example, different rider skill levels, needs, and priorities dictate how an E-Bikes will be used and their rider environments. Younger or more experienced rider may prefer a faster take off and higher cruising speeds whereas older or more inexperienced riders prefer a more gradual take off and slower cruising speeds. The riding environment is also critical to a rider preferential take off acceleration and cruising speed. If a user is commuting or in a hilly environment, they will prefer higher torque and acceleration in lower modes so that they can get to the target speed setpoint faster. Incremental acceleration in a commuting environment enables a user to get to their target speed faster and not stress as much about being a hinderance because they are not going with the flow of traffic. Hilly environments require additional torque/acceleration for climbing otherwise the user will need to switch modes or rely on the throttle more to maintain a comfortable riding feel.

Older riders in particular, prefer a gradual take off where they feel that they are in control of the E-Bike and desire a lower speed set point. Some parents tend to prefer this type of profile as well, especially if they are making trips with their children riding in the back. Current E-Bikes utilize a one size fits all programming mode for power assist propulsion systems where the E-Bike's cruising speed and more importantly take off acceleration cannot be set to a user's preference. Multiple user profiles enable different users to enjoy the same E-Bike and allows a user to be more thoughtful about their riding environment. For example, a more skillful rider may prefer a more graduate acceleration profile when riding with children on the rear rack. In addition, E-Bike riders sometimes change their location, or their primary use case, i.e., from leisure riding in parks to commuting in streets. Other riders develop a greater level of skill and comfort with operating their E-Bike. Consequently, a previously adequate acceleration profile can become obsolete or inadequate.

Multiple users sharing an E-Bike may also find it unwieldy to share the same acceleration profile. Thus, novel aspects of this disclosure provide additional flexibility and avoid the need to buy new E-Bikes, or continually reprogram an E-Bike, by providing a plurality of different acceleration profiles that can be used to control the E-Bike. In some embodiments, the user can manually select one of a plurality of acceleration profiles from a user-interface (UI) that is communicatively coupled with a motorized propulsion subsystem for propelling the E-Bike according to the selected acceleration profile, or the user can create a customizable acceleration profile from the UI. In other embodiments, the power assist propulsion system can automatically select one of a plurality of acceleration profiles, and in other embodiments still, the power assist propulsion system can automatically modify a selected acceleration profile based on environmental conditions, as described in more detail in the paragraphs that follow.

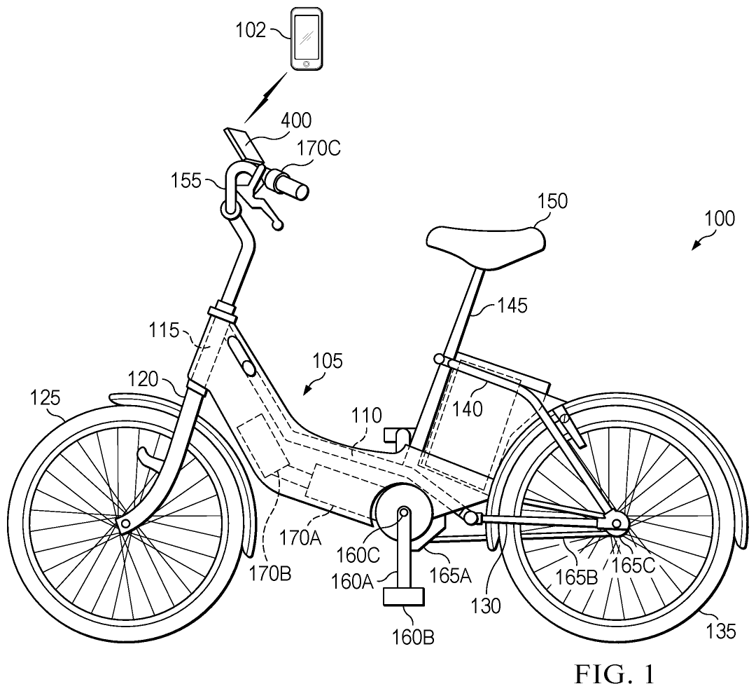

Referring first to FIG. 1, a rendering is provided of human-operated vehicle in accordance with an illustrative embodiment. The human-operated vehicle 100 is depicted as an E-Bike that can operate according to one of a plurality of acceleration profiles in accordance with the disclosed principles. Although embodiments of the disclosed system and associated methods are discussed herein as incorporated into the E-Bike 100, it should be understood that the selection and operation according to multiple acceleration profiles as disclosed herein may also be incorporated into other types of human-operated, power-assisted vehicles for propelling the vehicle, without departing from the scope of the disclosed principles.

The illustrated E-Bike 100 is comprised of a frame 105 having a main tube 110 extending along the length of the E-Bike 100. At the front of the main tube 110 is a head pipe 115 for securing the front forks 120 holding the front wheel 125. At the back of the main tube 110 is a rear wheel support consisting of rear forks 130 for securing the rear wheel 135. An upper support 140 is connected between the rear wheel 135 and the top of a seat post 145 for providing additional structural support for the rear wheel 135. A seat 150 is adjustably supported on the seat post 145. Handlebars 155 are connected to the top of the head pipe 115 for steering of the front wheel 125 of the E-Bike 100.

Propulsion of the E-Bike 100 can be achieved by a manual propulsion subsystem 160. In the depicted embodiment in FIG. 1, the manual propulsion subsystem 160 is located near the rear of the main tube 110. The manual propulsion subsystem (collectively 160) can drive the power assist propulsion system using manual input power from an operator of the E-Bike 100. In this embodiment, the manual propulsion subsystem 160 is comprised of cranks 160A, foot pedals 160B, and a crankshaft 160C used by the operator to manually pedal the E-Bike 100. Pedaling is achieved by opposing rotation of the cranks 160A via the pedals 160B, which in turn drives the crankshaft 160C that is supported on the frame 105 such that it may rotate within the transmission 165A of the drive assembly (collectively 165) that provides the driving force for the E-Bike 100. The transmission 165A, which includes gearing that may be changed via a controller or control panel (discussed below), typically drives a chain 165B of the drive assembly 165. The chain 165B, in turn, drives a sprocket 165C for rotating the rear wheel 135 to move the E-Bike 100. Depending on the model of E-Bike 100, the automatic transmission 165A may be any type of transmission, such as a continuously variable or a step-type transmission which both operate to vary the transmission gearing automatically. Of course, other types of transmissions, automatic or manual, may also be included. However, in accordance with E-Bikes having a power assist system as disclosed herein, an automatic transmission may be shifted in response to power assist requirements.

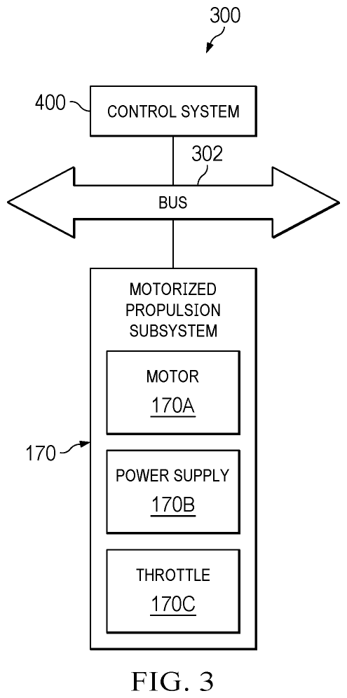

Propulsion of E-Bike 100 can also be achieved by a power assist propulsion system 300, shown in more detail in FIG. 3, which includes a motorized propulsion subsystem 170 controlled by control system 400. The power assist propulsion system 300 can propel the E-Bike 100 independently or in concert with the manual propulsion subsystem 160 based on control signals provided by the control system 400. The motorized propulsion subsystem (collectively 170) includes an electric motor 170A that uses electricity to drive the transmission 165A through a clutch mechanism, which may be of any advantageous type. The electric motor 170A is supplied with power from a local power supply 170B. In a non-limiting embodiment, the power supply 170B is an electrical power supply. In a more specific embodiment, the power supply 170B is a rechargeable battery 170B such as a lithium-ion battery; however, any type of battery or other power storage device may also be employed. In some embodiments, the motorized propulsion subsystem 170 of E-Bike 100 includes a throttle 170C, shown in more detail in FIG. 3, which provides input to the electric motor 170A to allow an operator to control the acceleration and/or maintain a desired cruising speed of the E-Bike 100.

When the power assist propulsion system 300 is used in concert with the manual propulsion subsystem 170, the power assist propulsion system 300 supplements the motive force generated by the user interacting with the manual propulsion subsystem 170 to reduce the amount of effort required to operate the E-Bike 100, or to provide addition power to achieve a desired rate of acceleration or top speed. In a non-limiting embodiment, the power assist propulsion system 300 helps to propel the E-Bike 100 according to one of a plurality of acceleration profiles stored in memory. An acceleration profile is a plurality of different speed setpoints over a predetermined speed range, each of the different speed setpoints associated with a rate of acceleration. For example, a Class 1 E-Bike can provide pedal assist up to 20 miles per hour (mph), so one acceleration profile can include a plurality of different speed setpoints dispersed throughout the 20-mph speed range.

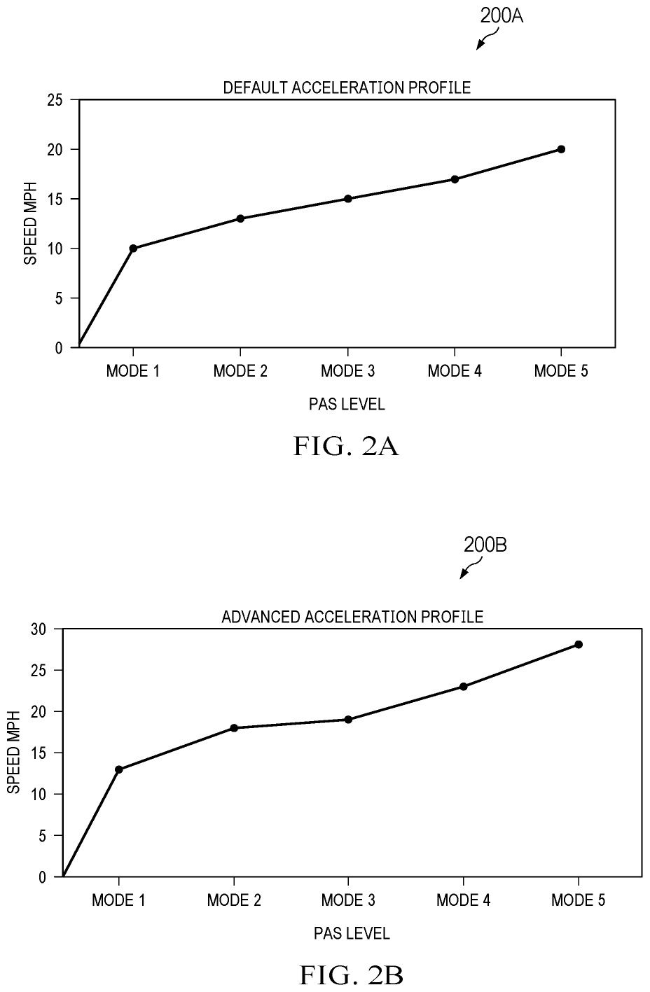

In some embodiments, each speed setpoint in an acceleration profile has the same rate of acceleration. In another embodiment, one or more of the speed setpoints of an acceleration profile have a different rate of acceleration than the other speed setpoints. An operator of the E-Bike 100 can select one of the plurality of acceleration profiles and then a speed setpoint and its corresponding rate of acceleration by selecting an operating mode of that acceleration profile, e.g., Modes 1-5 of a Default Acceleration Profile. An example of acceleration profiles is shown and described in more detail in FIG. 2 that follows.

Control system 400, which is formed from hardware and software, is represented as a module mounted to the handlebars 155 of the E-Bike 100 for the sake of simplicity. However, the various components of the control system 400 is formed from a plurality of components that can be distributed throughout the E-Bike 100. For example, sensor components may be distributed throughout the E-Bike 100 and the processing and memory components of the control system 400 can be housed in an enclosed location protected by frame elements. A user interface, such a touchscreen, can be mounted to the handlebars 155 for ease of access by an operator of the E-Bike 100. The user interface can also be provided to a user on the user's mobile communications device 102, which can be communicatively coupled to the control system 400 via conventional communications protocols. The user interface can allow the operator to select acceleration profiles or select menu items to help the control system 400 choose which acceleration profile to use. In some embodiments, the operator-selected acceleration profile is modified by the control system 400, and in some other embodiments still the control system 400 can automatically select an acceleration profile from the plurality of acceleration profiles for controlling operation of the motorized propulsion subassembly 170. Selection of acceleration profiles are described in more detail in the discussion of FIG. 3 that follows.

FIGS. 2A and 2B are charts of exemplary acceleration profiles in accordance with an illustrative embodiment. The acceleration profiles 200A and 200B are provided for controlling the power assist provided by power assist propulsion system 300 of E-Bike 100. In a non-limiting embodiment, acceleration profiles 200A and 200B are pre-loaded into memory of a power assist propulsion system of the E-Bike 100, as described in FIG. 2.

With particular reference to acceleration profile 200A in FIG. 2A, the predetermined speed range of 20 mph is divided into a plurality of different speed setpoints corresponding to a different operating mode, i.e., Mode 1 has a top speed of about 10 MPH, Mode 2 has a top speed of about 13 mph, Mode 3 has a top speed of about 15 mph, Mode 4 has a top speed of about 17 mph, and Mode 5 has a top speed of about 20 mph. Selection of acceleration profile 200A then one of the plurality of operating modes 1-5 will cause the control system 400 to generate the requisite control signals to cause the motorized propulsion subsystem 170 to provide power assist until the corresponding speed setpoint is achieved. As previously discussed, each of the operating modes 1-5 of acceleration profile 200A can have the same rate of acceleration; however, in a particularly advantageous embodiment the rates of acceleration can differ among the different operating modes. In one example, the rate of acceleration is commensurate with the magnitude of the step change between the speed setpoint of the selected operating mode and the speed setpoint of the preceding operating mode, if any. Mode 3 has a speed setpoint of 15 mph, and the speed setpoint of Mode 2, the preceding operating mode, is 13 mph. The corresponding step change is 2 mph. In comparison, Mode 1 has a speed setpoint of 10 mph for a step change of 10 mph since Mode 1 lacks a preceding operating mode. Because Mode 1 has a higher step change than Mode 3, Mode 1 has a correspondingly higher rate of acceleration than Mode 3.

With particular reference to acceleration profile 200B in FIG. 2B, the predetermined speed range of 28 mph is divided into a plurality of different speed setpoints corresponding to a different operating mode, i.e., Mode 1 has a top speed of about 13 MPH, Mode 2 has a top speed of about 17 mph, Mode 3 has a top speed of about 19 mph, Mode 4 has a top speed of about 23 mph, and Mode 5 has a top speed of about 28 mph. Selection of acceleration profile 200B then one of the plurality of operating modes 1-5 will cause the control system 400 to generate the requisite control signals to cause the motorized propulsion subsystem 170 to provide power assist until the corresponding speed setpoint is achieved. As previously discussed, each of the operating modes 1-5 of acceleration profile 200B can have the same rate of acceleration; however, in a particularly advantageous embodiment the rates of acceleration can differ among the different operating modes as previously described.

As can be seen, acceleration profile 200A in FIG. 2A has a lower overall top speed and lower intermediate speed setpoints relative to acceleration profile 200B. Acceleration profile 200A also has more gradual rates of acceleration than acceleration profile 200B. Thus, acceleration profile 200A is a default acceleration profile intended for users desiring a more leisurely experience, or for new users unfamiliar with the operation of E-Bike 100. Acceleration profile 200B, which provides higher speed setpoints and more aggressive rates of acceleration, is an advanced acceleration profile intended for experienced operators or riding conditions justifying higher top speed or greater rates of acceleration. For example, an operator on a leisurely ride may opt to set the E-Bike 100 in Mode 2 or Mode 3 of acceleration profile 200A, whereas an operator commuting on relatively empty roads may elect to set the E-Bike 100 in Mode 4 or Mode 5 of acceleration profile 200A. Likewise, a commuter in stop-and-go traffic may find a higher rate of acceleration to be more appropriate and may select Mode 1 of acceleration profile 200b, which provides the greatest rate of acceleration.

In some embodiments, the E-Bike 100 can be operated according to a smart acceleration profile that can incrementally adjust a selected acceleration profile if the riding environment is safe or more optimized via faster acceleration. Specific conditions include but are not limited to, detection commuting environment via GPS location and/or car traffic sensors or detection of a hilly terrain where incremental acceleration is required for better climbing capabilities. The smart acceleration profile can be determined wholly by the system controller 400 based on multiple forms of input including the operating environment, user competency, captured by one or more sensors, as described in more detail below.

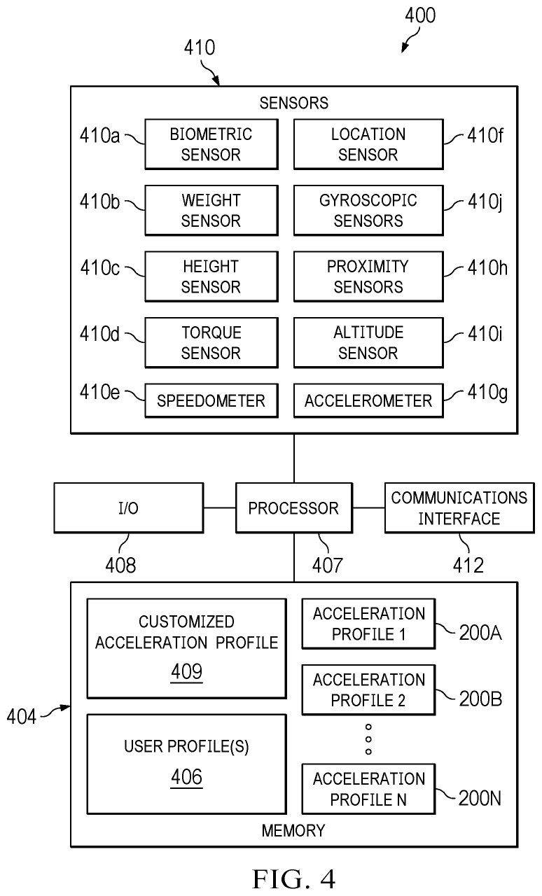

FIG. 3 is a block diagram of a power assist propulsion system for a user-rideable vehicle in accordance with an illustrative embodiment. The power assist propulsion system 300 includes a motorized propulsion subsystem 170 and a control system 400 connected via a system bus 302, but the use of the system bus 302 is exemplary and non-limiting. The control system 400 controls operation of the motorized propulsion subsystem 170 based on one or more acceleration profiles stored in memory and from input received from one or more sensors, as described in more detail in FIG. 4 that follows. The sensors can detect metrics such as speed, acceleration, user exertion, and orientation, to name a few.

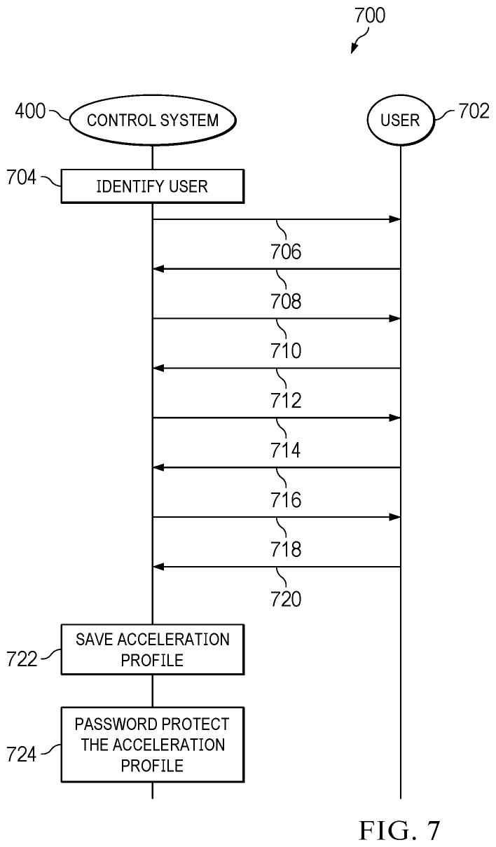

FIG. 4 is a block diagram of a control system in accordance with an illustrative embodiment. The control system 400 controls the motorized propulsion system 170 based on one or more acceleration profiles 200 and/or customized acceleration profile 409 stored in memory 404. The one or more acceleration profiles 200 can be predefined acceleration profiles that provide a variety of riding experience suitable for a wider user base. Examples of acceleration profiles 200 can include the acceleration profiles in FIG. 2 and/or the acceleration profiles in Table 1. The customized acceleration profile 409 can be created by a user based on a variety of personal preferences, such as level of expertise and riding environment. The creation of a customized acceleration profile is described in more detail in FIG. 7.

Memory 404 is one or more storage devices that can be any structure(s) capable of storing and facilitating retrieval of information (such as data, program code, and/or other suitable information on a temporary or permanent basis). The memory 404 may represent a random-access memory or any other suitable volatile or non-volatile storage device(s). In some embodiments, user profile(s) 406 can also be stored in memory 404. User profile(s) 406 is a set of one or more user profiles storing user-specific data, such as passwords, biometric identifiers, physical characteristics, operating preferences, and the like.

The processor 407 can execute instructions (not shown) in memory 404 for controlling the selection or identification of an acceleration profile and the subsequent operation of the motorized propulsion subsystem 170 according to one of the plurality of acceleration profiles, such as acceleration profiles 200 and/or customized acceleration profile 409. The processor 407 may include any suitable number(s) and type(s) of processors or other devices in any suitable arrangement. Example types of processors 404 include microprocessors, microcontrollers, digital signal processors, field programmable gate arrays, application specific integrated circuits, and discreet circuitry.

In the exemplary embodiment in FIG. 4, the acceleration profiles include N acceleration profiles, identified as acceleration profiles 200A, 200B, and 200N. Acceleration profile 200A includes a first plurality of operating modes, each of the first plurality of operating modes defined by a different top speed and a corresponding rate of acceleration. Acceleration profile 200B includes a second plurality of operating modes, each of the second plurality of operating modes defined by a different top speed and a corresponding rate of acceleration. In a non-limiting embodiment, step changes between the different top speeds of the second acceleration profile is greater than those in acceleration profile 200A.

In some embodiments, the set of acceleration profiles includes a first acceleration profile with at least two operation modes. A speed setpoint of the first operation mode is lower than a speed setpoint of the second operation mode and a first rate of acceleration of the first operation mode is higher than a second rate of acceleration of the second operation mode. In one or more embodiments, the first acceleration profile has an intermediate operation mode between the first operation mode and the second operation mode, and the intermediate operation mode has an intermediate speed setpoint between the first top speed and the second top speed. Additionally, the intermediate operation mode has a third rate of acceleration that is less than the first rate of acceleration and the second rate of acceleration.

In one or more embodiments, the set of acceleration profiles includes a second acceleration profile in addition to the first acceleration profile. The second acceleration profile also has at least two operation modes with a first speed setpoint of the first operation mode being lower than a second speed setpoint of a second operation mode. Additionally, the speed setpoint of the first operation mode of the second acceleration profile is higher than the speed setpoint of the first operation mode of the first acceleration profile, and the speed setpoint of the second operation mode of the second acceleration profile is higher than the speed setpoint of the speed setpoint of the second operation mode of the first acceleration profile. Further, the rate of acceleration of the first operation mode of the second acceleration profile can be greater than the rate of acceleration of the first operation mode of the first acceleration profile, and the rate of acceleration of the second operation mode of the second acceleration profile can be greater than the rate of acceleration of the second operation mode of the first acceleration profile. In some embodiments, the second acceleration profile is accessible to a user after the user completes a competency program.

In a non-limiting embodiment, the set of acceleration profiles includes at least three pre-defined acceleration profiles for selection. One of the acceleration profiles can be a default acceleration profile with a plurality of predetermined operational modes, each of which is associated with a predetermined speed setpoint. Additionally, each of the operational modes can include an associated rate of acceleration, i.e., power output. The predetermined speed setpoints and rates of acceleration can be selected to provide the most desirable riding experience for the broadest base of users. In this non-limiting embodiment, the set of acceleration profiles can also include a reduced acceleration profile that has the same operational modes and speed setpoints as the default acceleration profile, but with relatively lower rates of acceleration for each operational mode. This non-limiting embodiment can also include a more responsive acceleration profile that has at least some of the same operational modes and speed setpoints as the default acceleration profile, but with relatively higher rates of acceleration for each operational mode.

Table 1 depicts an exemplary set of acceleration profiles illustrating a default acceleration profile (B), reduced acceleration profile (A), and responsive acceleration profile (C). In this embodiment, the rate of acceleration is controlled by controlling the power (i.e., amperage) provided to the electric motor. Accordingly, higher amperages equate to higher power and also higher rates of acceleration when all other variables are held constant. Thus, relative rates of acceleration can be described based on relative amounts of accessible power.

TABLE 1
Exemplary Acceleration Profiles.

| | | |
|---|---|---|
| Operational Mode | Speed Setpoint (MPH) | Power (Amps) |

Reduced acceleration profile (A)
Total power output = 14 amps

| | | |
|---|---|---|
| 1 | 11 | 2 |
| 2 | 13 | 4 |
| 3 | 17 | 6 |
| 4 | 22 | 8 |
| 5 | 28 | 12 |

Default acceleration profile (B)
Total power output = 14 amps

| | | |
|---|---|---|
| 1 | 11 | 4 |
| 2 | 13 | 6 |
| 3 | 17 | 8 |
| 4 | 22 | 10 |
| 5 | 28 | 14 |

Responsive acceleration profile (C)
Total power output = 14 amps

| | | |
|---|---|---|
| 1 | 11 | 5 |
| 2 | 13 | 8 |
| 3 | 17 | 10 |
| 4 | 22 | 12 |
| 5 | 28 | 14 |

In one embodiment, selection of one of the plurality of acceleration profiles 200 or customized acceleration profile 409 can be made by an operator interfacing with an I/O unit 408. The I/O unit 408 may allow for input and output of data. For example, the I/O unit 408 can provide a connection for user input through a keyboard, mouse, keypad, touchscreen, or other suitable input device. The I/O unit 408 can also send output to a display or other suitable output device. In one embodiment, the I/O unit 408 includes a user interface attached to the handlebars of the E-Bike 100 to facilitate operation by a user. The user interface can be a touch screen for receiving operator input, or a digital display and a manual switch. In either embodiment, the user can be provided with a list of acceleration profiles for manual selection by the user prior to or during operation of the E-Bike 100.

In some embodiments, the selection of one of the plurality of acceleration profiles 200 or customized acceleration profile 409 can be made automatically by the power assist propulsion system 300. For example, if the power assist propulsion system 300 can identify the user, then a preferred acceleration profile can be automatically selected based on the identity of the user and then used for controlling the operation of the E-Bike 100. The user can be identified by a unique password provided via an I/O unit 408, or by one or more sensors in the set of sensors 410. As an example, biometric sensor 410a can be any one or more sensors configured to capture a user's biometric identifier, such as a fingerprint scanner or an iris scanner. The biometric identifier captured by the biometric sensor 410a can be compared with biometric identifiers stored in user profile(s) 406 for identifying a user. Likewise, weight sensor 410b is a sensor that can be configured to detect the weight of a user, which can be correlated with a weight attribute stored in user profile(s) 406 for identifying the user. The weight sensor 410b can be coupled to the seat or a frame element for detecting the user's weight. In addition, or in the alternative, the user can be identified by a height sensor 410c that can be used to determine an approximate height of a user. For example, the height sensor 410c can be used to determine a user's height based on the loft of the seat of E-Bike 100. Higher seat settings may be used to infer taller riders whereas lower seat settings may be used to infer shorter riders. Riders' heights may be stored in user profile(s) 406 for subsequent identification.

In another embodiment, a user can be identified by the pairing of the user's personal computing device (e.g., smart phone, smart watch, or tablet, etc.) with the power assist propulsion system 300 via communications interface 412. The communications interface 412 supports communications with other systems or devices. For example, the communications interface 412 could include a network interface card or a wireless transceiver facilitating communications over a network, such as the internet. The communications interface 412 may support communications through any suitable physical or wireless communication link(s), such as BLUETOOTH® or similar near field communications protocol. Pairing of the user's personal computing device with the communications interface 412 can notify the power assist propulsion system 300 of the unique identifier of the personal computing device 102, which can be associated with a particular user based on information maintained in user profile(s) 406.

Once an acceleration profile is selected from the plurality of acceleration profiles 200 or customized acceleration profile 409, the processor 407 controls operation of the E-Bike 100 according to the selected acceleration profile. The processor 407 can control the motorized propulsion subsystem 170 to either provide the entirety of the motive force for propelling the E-Bike 100 or to supplement the manual input provided by an operator interacting with the manual propulsion subsystem 160. Supplementation of the user-provided motive force at the manual propulsion subsystem 160 can be achieved conventionally, i.e., by detecting the amount of input force via torque sensor 410d, and then providing an additional force to propel the E-Bike 100 based on the magnitude of the detected torque and in accordance with the selected acceleration profile and operating mode.

In one aspect, control of the operation of E-Bike 100 includes controlling the amount of power assist provided based on the speed of the E-Bike 100, which varies depending on the selected acceleration profile and the selected operating mode. The speed of the E-Bike 100 can be determined by a speedometer 410e. The speedometer 410e can determine the speed of the E-Bike 100 using any type of conventionally known or later developed technology and/or methodology. For example, the speedometer 410e may be a device configured to detect the amount of rotational movement of a component of the E-Bike 100, such as one of the axles of the wheels. That amount of rotational movement may then be provided to the processor 407, which can then calculate the speed of E-Bike 100. In another embodiment, the speed of the E-Bike 100 can be extrapolated based on data captured by location sensor 410f. For example, the location sensor 410f can be a GPS-type device that can provide location data to the processor 407 for determining a speed of the E-Bike 100 based on a change of location over a predetermined period of time.

In another aspect, control of the operation of E-Bike 100 includes controlling the amount of power assist to achieve not only the speed setpoint of the selected operating mode, but also controlling the amount of power assist to achieve the speed setpoint according to a corresponding rate of acceleration of the E-Bike 100, which is also based on the selected operating mode. Thus, the amount of power assist provided can be determined by the amount necessary for accelerating the E-Bike 100 according to the rate of acceleration of the selected operating mode. In the event that an operator elects to accelerate the E-Bike 100 with a throttle rather than by interacting with the manual propulsion subsystem 160, the amount of power provided by the motorized propulsion subsystem 170 can also follow the same rate of acceleration. In either scenario, the rate of acceleration of the E-Bike 100 can be determined by an accelerometer 410g, or by any other currently existing or later developed means.

In some embodiments, the selected acceleration profile can be modified during operation of the E-Bike 100 based on environmental conditions. An example of environmental conditions can include the presence of traffic. Presence of traffic can be detected by proximity sensors 410h, or by inference based on the location of the E-Bike 100 on a roadway (as determined by a location sensor 410f) during rush hour, or by an operating pattern indicative of stop-and-go traffic. In any event, the acceleration profile can be modified to accommodate for the actual or inferred presence of traffic. For example, the top speed of the E-Bike 100 can be reduced and the rate of acceleration can be increased. The sensitivity of the throttle can also be increased so that full power can be accessed by toggling the throttle halfway, rather than the standard full power at full throttle. Additionally, the E-Bike 100 and/or the user's mobile communication device 102 can be configured to notify the user of approaching traffic or other objects. Exemplary notifications can include a visual indicator, such as a change in color of a screen of the user's mobile communication device 102 or a screen of the control system 400, if any. The notification can also be a tactile indicator, such as a vibration in the handlebars or the seat.

Another example of an environmental condition is terrain. For example, if the power assist propulsion system 300 determines that the E-Bike 100 is on hilly terrain, then the acceleration profile can be modified to increase the rate of acceleration to provide more assistance on climbs. In an exemplary use case, a user operating E-Bike 100 in a pedal assist mode with a speed setpoint of 13 MPH and a corresponding power of 8 amps is climbing a hill but unable to achieve the top speed of 13 MPH despite the consistent application of manual input at the pedals. The power assist propulsion system 300 can increase the power to allow the user to achieve the desired speed setpoint while going uphill. In one embodiment, the power assist propulsion system 300 increases the power according to a predetermined value or based on a predetermined percentage. In another embodiment, the power assist propulsion system 300 increases the power to a value that allows the user to achieve and/or maintain the desired acceleration profile. Upon detecting that the E-Bike 100 has reached the top of the hill, or is approaching the top of the hill, the power assist propulsion system 300 can reduce the power back to the original power, e.g., 8 amps in the non-limiting example.

In some embodiments, the hilly terrain can be detected by an altitude sensor 410i that measures an altitude of the E-Bike 100. Constant altitude changes can be indicative of hilly terrain. In another embodiment, hilly terrain can be detected by a gyroscopic sensor 410j that determines the changing pitch of the E-Bike 100.

Environmental conditions can also include weather affecting road conditions. Weather can be inferred based on weather forecasting, which can be received via the communications interface 412 connected to a user's personal computing device or via the internet. Weather conditions can also be detected by rain sensors (not shown) or wheel sensors (not shown) detecting lack of traction. In inclement weather, the acceleration profile can be modified to decrease top speed and also rate of acceleration.

In some embodiments, the selected acceleration profile can be modified during operation of the E-Bike 100 based on a user's physiological measurements, such as heart rate. Heart rate and other forms of measurements can be obtained using a sensor integrated into the handlebars of the E-Bike 100, or from a remote sensor such as smart watch or chest strap monitor communicatively coupled with the control system 400 via conventional communications protocols. The control system 400 can change the power supplied to the motor based on the target measurement. For example, the control system 400 can increase the power to reduce the user's level of exertion if the user's heart rate is too high. Alternatively, the control system 400 can decrease the power to increase the user's level of exertion if the user's heart rate is not high enough, particularly if the user is attempting to keep a heart rate within a certain range to obtain the benefits of an aerobic workout.

Although the exemplary power assist propulsion system 300 includes a plurality of different sensor types, one or more of the sensors can be omitted so that those processing tasks can be deferred to the user's personal computing device. For example, most smartphones include GPS, accelerometers, and gyroscopes. Communicatively coupling the user's smartphone with the communications interface 412 still allows the power assist system 300 to avail itself to those datasets while reducing vehicle cost and weight, as well as preserving battery life.

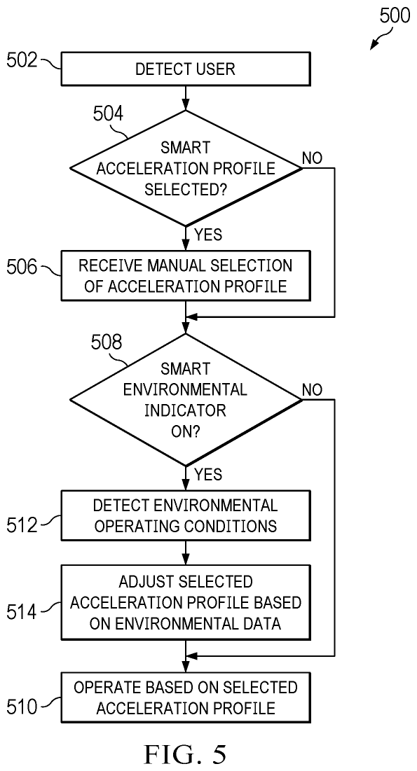

FIG. 5 is a flowchart of a process for selecting one of a plurality of acceleration profiles in accordance with an illustrative embodiment. Flowchart 500 can be performed by power assist propulsion system 300.

Flowchart 500 begins at step 502 by detecting a user. The user can be detected by one of the set of sensors 410. For example, a motion sensor or a proximity sensor can be used to detect the user. In one embodiment, the detection of the user can also include identifying the particular user. As previously described, the user can be identified by provision of a unique password, by one of the set of sensors 410, or by pairing with the user's personal computing device.

In step 504, a decision is made as to whether a smart acceleration profile is selected. The smart acceleration profile can be selected manually by a user interfacing with the I/O unit 408 or by the user interfacing with the user's personal computing device that is communicatively coupled with the power assist propulsion system 300. In another embodiment, the smart acceleration profile can be selected automatically based upon a particular user's default settings once the user is identified. For example, if a particular user is detected in step 502, i.e., based on the user's biometrics, the user's personal computing device, or some sort of extrinsic characteristic, such as user's weight, and the user has a setting that automatically choose to select a smart acceleration profile, then the smart acceleration profile can be automatically selected once the user is detected and identified.

If a determination is made in step 504 that the smart acceleration profile is not selected, then flowchart 500 proceeds from step 504 to step 506 and a manual selection of an acceleration profile is received. The manual selection of the acceleration profile can be made in response to a prompt provided to the user via the I/O unit 408, or via the user's personal computing device. In some embodiments, the selection of the acceleration profile can be received automatically, as in the instance where a user's preferred acceleration profile is stored in memory and selected automatically if the particular user is identified.

From step 506, or from step 504 if a determination is made that a smart acceleration profile is not selected, flowchart 500 proceeds to step 508 where a determination is made as to whether a smart environmental indicator is on. If the smart environmental indicator is not on, then flowchart 500 continues to step 510 where operation of the E-Bike 100 is controlled based on the selected acceleration profile.

If, in step 508, the determination is made that the smart environmental indicator is on, then flowchart 500 proceeds from step 508 to step 512 where the environmental operating conditions are detected. Environmental operating conditions of the E-Bike 100 can be detected by the sensors 410 of the power assist propulsion system 300 as described in more detail in FIG. 3 above. In step 514, the acceleration profile is adjusted based on the environmental data collected by the set of sensors 410 in step 512, and flowchart 500 proceeds to step 510 where the E-Bike 100 operation is controlled based on the adjusted acceleration profile.

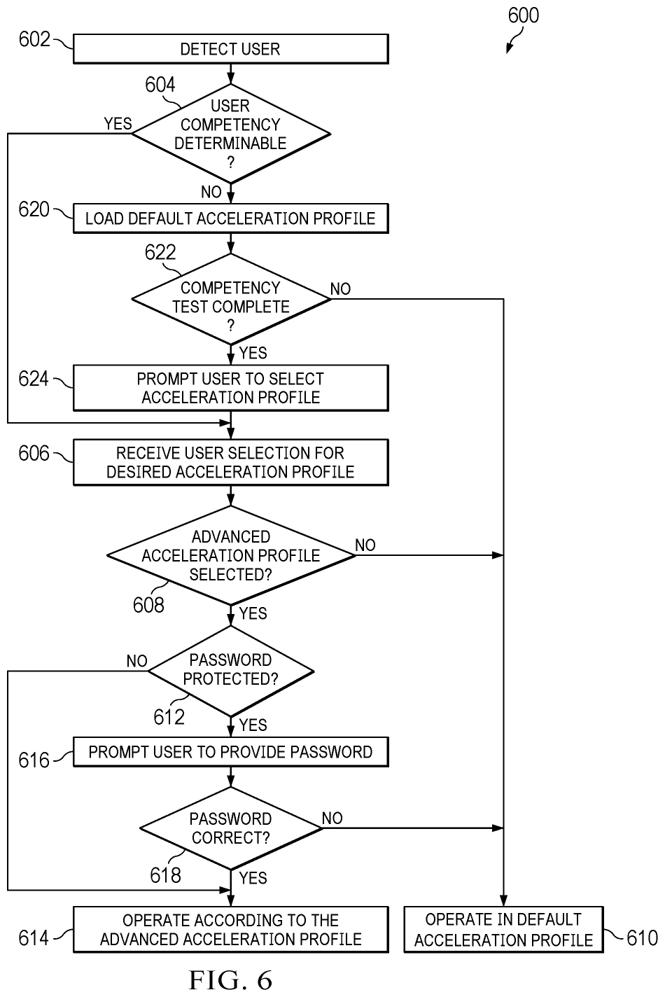

FIG. 6 is a flowchart of a process for selecting one of a plurality of acceleration profiles in accordance with an illustrative embodiment. Steps of flowchart 600 can be performed by power assist propulsion system 300 of a user-rideable vehicle, such as E-Bike 100 in FIG. 1.

Flowchart 600 begins at step 602 by detecting a user. Step 602 is a detection step, like detection step 502 in FIG. 5. Thereafter, a determination is made in step 604 as to whether a user's competency can be determined. If the user's competency can be determined, then flowchart 600 proceeds to step 606 where a user's desired acceleration profile selection is received.

In step 608 a determination is made as to whether the desired acceleration profile is an advanced acceleration profile. If the desired acceleration profile is not an advanced acceleration profile, then flowchart 600 proceeds to step 610 where a default acceleration profile is used for operating the E-Bike 100.

Returning to step 608, if the desired acceleration profile is an advanced acceleration profile, then flowchart 600 proceeds to step 612 where another determination is made as to whether the advanced acceleration profile is password protected. If the desired advanced acceleration profile is not password protected, then the E-Bike 100 is operated according to the desired advanced acceleration profile in step 614. However, if the desired advanced acceleration profile is password protected, then flowchart 600 proceeds from step 612 to step 616 where a user is prompted to provide the password.

In step 618 a determination is made as to whether the received password is correct. If the password is correct, then flowchart 600 proceeds to step 614 and operation of the E-Bike 100 is controlled based on the desired advanced acceleration profile. However, if the password is not correct, then the flowchart 600 proceeds from step 618 to step 610 where operation of the E-Bike 100 is controlled according to the default acceleration profile.

In some embodiments, advanced acceleration profiles are secured from unauthorized access by other means. For example, rather than a password, a user can unlock an acceleration profile by providing a biometric identifier, such as a fingerprint or an iris scan.

Returning to step 604, if the user's competency cannot be determined, then the default acceleration profile is loaded in step 620. After a period of time has elapsed, a determination is made as to whether a competency test has been completed in step 622. A competency test is a series of one or more criteria that must be satisfied before an operator of the E-Bike 100 can be deemed to be competent. In the simplest embodiment, the competency test can be a predetermined distance traveled. Once an operator has traveled the predetermined distance, then the operator is deemed to be competent in operating the E-Bike 100. In other embodiments, the competency test can include any number of different criteria, such as operation of the E-Bike 100 in one or more different operating environments, i.e., on roadways, on hilly terrain, in traffic, or in inclement weather. Other types of criteria can be operating the E-Bike 100 to accomplish a predetermined series of maneuvers, rates of acceleration and deceleration, etc.

In step 622, if the determination is made that the competency test has not been completed, then flowchart 600 proceeds to step 610. However, in step 622, if the determination is made that the competency test has been completed, then flowchart 600 proceeds from step 622 to step 624 and prompts the user to select an acceleration profile and flowchart 600 continues on to step 606.

The power assist propulsion system 300 can also be configured to allow users to create and save customized acceleration profiles. For example, a single user can create a plurality of acceleration profiles, each for a particular use case, e.g., commuting, leisure, exercise, etc., or a plurality of users can each create an individualized acceleration profile. Customized acceleration profiles can be created on a user interface. In one example, the user interface can be I/O 408 in control system 400. In another example, the user interface can be the user's personal computing device that is communicatively coupled with the control system 400 via communications interface 412.

FIG. 7 is a swim lane diagram depicting data flow for creating a customized acceleration profile in accordance with an illustrative embodiment. In diagram 700, control system 170 creates and saves a customized acceleration profile generated by user 702.

In a non-limiting embodiment, control system 170 identifies the user 702 in step 704. The user 702 can be identified by pairing with the user's mobile communications device, by one or more biometric identifiers, or some form of unique identifier, such as a username and password combination. Once the user is identified, the subsequently generated, customized acceleration profile can be saved to the appropriate user profile. Unidentified or unidentifiable users may be prompted to create a user profile so that the subsequently generated, customized acceleration profile can be saved.

In step 706, control system 170 prompts the user to select a number of pedal assist modes for the customized acceleration profile and the user provides a response in step 708. In step 710, control system 170 prompts the user 702 to identify a target speed for each pedal assist mode, and the user provides a response in step 712. In step 714, control system 170 prompts the user to identify a rate of acceleration for each pedal assist mode, and the user provides a response in step 716.

In step 718 the control system 170 prompts the user to select a sensitivity for the throttle. For example, higher sensitivity can equate to greater power with less travel. The user provides a response in step 720. The customized acceleration profile is saved in step 722, and in some embodiments the acceleration profile is password protected in step 724.

In diagram 700, the control system 170 provides a series of prompts to the user to make selections that can be used to generate the customized acceleration profile. However, in alternate embodiments, options can be provided to the user 702 simultaneously on an electronic form, mobile application, or any other conventional user interface. Selections can be made by entering responses in a text field, by making a selection from a prepopulated menu, or by interacting with interactive user inputs, like scroll bars.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A power assist propulsion system for a user-rideable vehicle, the power assist propulsion system comprising:
a motorized propulsion subsystem configured to interface with a manual propulsion subsystem, wherein the motorized propulsion subsystem can propel the vehicle in concert with the manual propulsion subsystem or independently of the manual propulsion subsystem; and
a control system that includes:
memory storing a set of acceleration profiles and instructions, and
a processor communicatively coupled to the memory and the motorized propulsion subsystem, wherein the processor executes the instructions to generate a customized acceleration profile based on inputs received from a user, wherein the inputs define a number of operating modes, a speed setpoint for each of the number of operating modes, and a power output for each of the number of operating modes, and wherein:
the customized acceleration profile is saved as one of the set of acceleration profiles, and
the processor controls the motorized propulsion subsystem based on a selected acceleration profile from the set of acceleration profiles.

2. The power assist propulsion system of claim 1, wherein the motorized propulsion subsystem includes a throttle, and wherein the inputs received from the user defines a sensitivity of the throttle.

3. The power assist propulsion system of claim 1, wherein the user inputs are provided on a user interface of the control system or on a mobile communications device communicatively coupled to the control system.

4. The power assist propulsion system of claim 1, wherein the control system further comprises a set of sensors configured to detect environmental conditions, and wherein the control system executes the instructions to modify the selected acceleration profile based on the detected environmental conditions.

5. The power assist propulsion system of claim 4, wherein the detected environmental condition is an inclined grade, and wherein the selected acceleration profile is modified to temporarily increase an amount of power available for increasing a rate of acceleration.

6. The power assist propulsion system of claim 4, wherein the detected environmental condition is traffic, and wherein the selected acceleration profile is modified to increase a sensitivity of a throttle, temporarily increase an amount of power available for increasing a rate of acceleration, or temporarily increase a speed setpoint.

7. The power assist propulsion system of claim 1, wherein the control system further comprises a set of sensors configured to detect a physiology of a user, and wherein the control system executes the instructions to modify the selected acceleration profile based on the detected physiology of the user.

8. The power assist propulsion system of claim 1, wherein the memory further stores a set of user profiles, and wherein each of the set of user profiles is associated with one or more acceleration profiles from the set acceleration profiles.

9. The power assist propulsion system of claim 1, wherein at least some operating modes with a speed setpoint that exceeds a speed threshold or a power that exceeds a power threshold are accessible upon providing a corresponding password or displaying sufficient competency.

10. The power assist propulsion system of claim 1, wherein the control system further comprises a communications interface that receives additional instructions from a mobile communications device for generating a new customized acceleration profile or modifying one or more acceleration profiles from the set of acceleration profiles.

11. A vehicle comprising:
a manual propulsion subsystem; and
a power assist propulsion system coupled with the manual propulsion system, the power assist propulsion system including:
a motorized propulsion subsystem that interfaces with the manual propulsion subsystem, wherein the motorized propulsion subsystem can propel the vehicle in concert with the manual propulsion subsystem or independently of the manual propulsion subsystem; and
a control system that includes memory storing a set of acceleration profiles and instructions, and a processor communicatively coupled to the memory and the motorized propulsion subsystem, wherein the processor executes the instructions to generate a customized acceleration profile based on inputs received from a user, wherein the inputs define a number of operating modes, a speed setpoint for each of the number of operating modes, and a power output for each of the number of operating modes, and wherein:
the customized acceleration profile is saved as one of the set of acceleration profiles, and
the processor controls the motorized propulsion subsystem based on a selected acceleration profile from the set of acceleration profiles.

12. The vehicle of claim 11, wherein the motorized propulsion subsystem includes a throttle, and wherein the inputs received from the user defines a sensitivity of the throttle.

13. The vehicle of claim 11, wherein the user inputs are provided on a user interface of the control system or on a mobile communications device communicatively coupled to the control system.

14. The vehicle of claim 11, wherein the control system further comprises a set of sensors configured to detect environmental conditions, and wherein the control system executes the instructions to modify the selected acceleration profile based on the detected environmental conditions.

15. The vehicle of claim 14, wherein the detected environmental condition is an inclined grade, and wherein the selected acceleration profile is modified to temporarily increase an amount of power available for increasing a rate of acceleration.

16. The vehicle of claim 14, wherein the detected environmental condition is traffic, and wherein the selected acceleration profile is modified to increase a sensitivity of a throttle, temporarily increase an amount of power available for increasing a rate of acceleration, or temporarily increase a speed setpoint.

17. The vehicle of claim 11, wherein the control system further comprises a set of sensors configured to detect a physiology of a user, and wherein the control system executes the instructions to modify the selected acceleration profile based on the detected physiology of the user.

18. The vehicle of claim 11, wherein the memory further stores a set of user profiles, and wherein each of the set of user profiles is associated with one or more acceleration profiles from the set acceleration profiles.

19. The power assist propulsion system of claim 1, wherein at least some operating modes with a speed setpoint that exceeds a speed threshold or a power that exceeds a power threshold are accessible upon providing a corresponding password or displaying sufficient competency.

20. The vehicle of claim 11, wherein the control system further comprises a communications interface that receives additional instructions from a mobile communications device for generating a new customized acceleration profile or modifying one or more acceleration profiles from the set of acceleration profiles.
